(19) United States
(12) Patent Application Publication
(10) Pub. No.: US 2021/0098859 A1
(43) Pub. Date: Apr. 1, 2021

(54) Highly Flexible Antenna Made of Bonding Wires

(71) Applicant: ACOUSTIC INNOVATION (HUIZHOU) CO. LTD, Huizhou (CN)

(72) Inventors: Chee Kit YUEN, Hong Kong (CN); Wai Yin MUNG, Hong Kong (CN); Ka Ming WU, Hong Kong (CN)

(21) Appl. No.: 16/589,292

(22) Filed: Oct. 1, 2019

(51) Int. Cl. H01Q 1/22; H01Q 9/16; H01Q 9/30

(52) U.S. Cl. CPC H01Q 1/2283; H01Q 9/30; H01Q 9/16

(57) ABSTRACT

The present invention belongs to the field of communication technology and discloses a highly elastic antenna made of bonding wires, which comprises a base plate, a line matched transformer, bonding wires, a primary PCB, a secondary PCB and a line inlet. The upper part of the said base plate is provided with a line matched transformer, a bonding wire, a primary PCB and a secondary PCB, one end of the said primary PCB is connected to the line inlet, a line matched transformer is fixed on the upper part of the primary PCB, and the primary PCB is connected to the secondary PCB via bonding wires. In the present invention, bonding wires are employed as a component of antenna radiant elements. As a radiating antenna, the bonding wire may extend into the third dimensional space via its height, thus reducing the space occupied by the antenna on the PCB. One or more bonding wires may be used for different PCB antennas and the resonant frequency may be adjusted by the length or height of the bonding wire.

### FIELD OF THE INVENTION

The invention particularly relates to a highly elastic antenna made of bonding wires, and belongs to the field of communication technology.

### BACKGROUND OF THE INVENTION

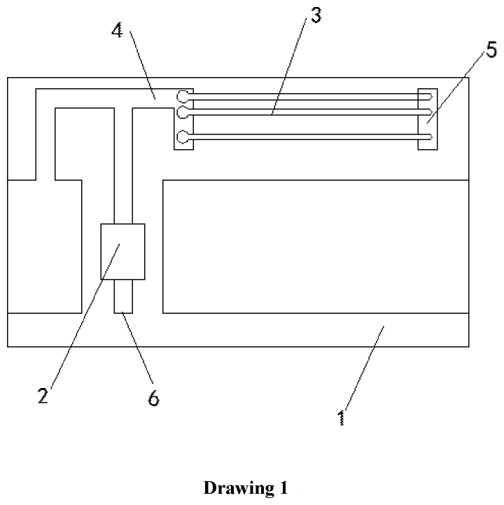

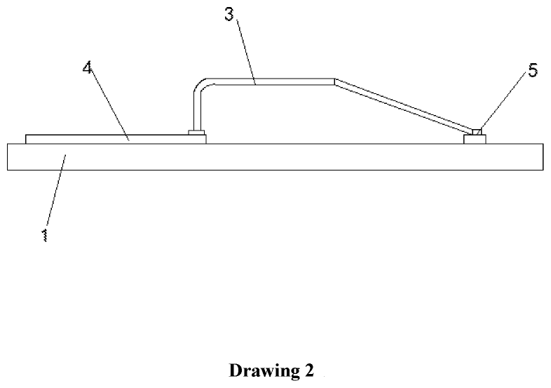

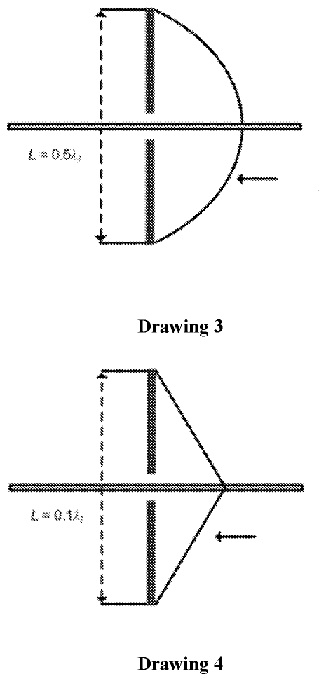

The traditional 2.4 GHz ISM band (Industrial Scientific Medical Band) antenna is placed on a PCB. There are many existing size reduction solutions, one of which involves a common type of low temperature co-fired ceramic (LTCC) antenna. It is available in different sizes and lengths in LTCC antennas, for example 7 mm, 5 mm and 3 mm. FIG. 3 shows that an incident electric field propagates to a vertical dipole of length L=0.5 λ1, where λ1 is the wavelength used. If the current distribution of the dipole is uniform, an actual sinusoidal current distribution will be almost presented. If the same dipole is used at a longer wavelength λ2, then it is only L=0.1 λ2 long. In FIG. 4, the current decreases almost linearly to zero from a center feed point. Assuming that the dipole has a uniform current distribution, the radiation resistance (Rrad) in the free space and the air space is

$${R}_{rad} = 80 {{π}^{2} ( \frac{L}{λ} )}^{2} .$$

For the triangular current distribution shown in FIG. 4, the radiation resistance is smaller than in FIG. 3. A small value of the radiation resistance indicates that the performance of an antenna is not very efficient. The antennas with a small length but incorrect resonant frequency result in poor overall performance because their resonant frequency is higher than the operating frequency. Hence, a matching network is required to recover the correct resonant frequency. The matching network is used for the maximum power transmission from a radio transceiver to antennas. However, the antenna is still inefficient and results in additional costs and circuit areas.

The above paragraph mentions that a general LTCC antenna has been tuned to the 2.4 GHz ISM band on the manufacturer's test board. Since a frequency shift occurs with an antenna being placed in the casing, final fine tuning (matching the loaded capacitance or inductance on the antenna) is required, but its operating resonant frequency is still not in the 2.4 GHz ISM band. Even if the antenna meets its working frequency length, its working frequency will still shift when placed in the casing, and finally the matching line has to be used for adjustment.

Invention Content

The present invention is intended to overcome the existing technical defect by providing a highly elastic antenna made of bonding wires that serve as a component of antenna radiating elements. As a radiating antenna, the bonding wire may extend into the third dimensional space via its height, thus reducing the space occupied by the antenna on the PCB. One or more bonding wires may be applied to different PCB antennas and the resonance frequency may be adjusted by using the length or height of the bonding wire, which can effectively solve the problems in the background art.

In order to solve the above technical problem, the present invention provides the following technical schemes:

The invention provides a highly elastic antenna made of bonding wires, comprising a base plate, a line matched transformer, bonding wires, a primary PCB, a secondary PCB and a line inlet. The upper part of the said base plate is provided with a line matched transformer, bonding wires, a primary PCB, and a secondary PCB, One end of the said primary PCB is connected to the line inlet, a line matched transformer is disposed in the upper part of the primary PCB, and the said primary PCB is connected to the secondary PCB through a bonding wire.

As a preferred technical scheme of the present invention, the said bonding wire contains one or more wires.

As a preferred technical scheme of the present invention, both ends of the said bonding wire are soldered to the upper part of the primary PCB and the secondary PCB, respectively.

As a preferred technical scheme of the present invention, one end of the said bonding wire is perpendicular to the primary PCB, and the bonding wire is of an arched structure.

As a preferred technical scheme of the present invention, the said bonding wire is placed at different heights.

As a preferred technical scheme of the present invention, the said bond wire may be applied to any double-doublet antenna or monopole antenna design on a PCB.

The following beneficial effects are achieved by the present invention: a highly elastic antenna made of bonding wires, wherein the bonding wire is employed as a component of antenna radiant elements. As a radiating antenna, the bonding wire may extend into the third dimensional space via its height, thus reducing the space occupied by the antenna on the PCB. One or more bonding wires may be used for different PCB antennas and the resonant frequency may be adjusted by the length or height of the bonding wire.

### DRAWINGS

The drawings are intended to provide a further understanding of the invention, to constitute a part of the specification of the invention, and to explain the invention together with the embodiments of the invention, all of which do not constitute a limitation on the invention.

In the drawings:

Drawing 1 is a sketch diagram showing the overall structure of a highly elastic antenna made of bonding wires according to an embodiment of the present invention;

Drawing 2 is a side view of a highly elastic antenna made of bonding wires according to an embodiment of the present invention;

Drawing 3 is a sketch diagram showing that the current decreases almost linearly to zero from a center feed point;

Drawing 4 is a triangle current distribution diagram;

Numbers in the drawing: 1. Base plate; 2. Line matched transformer; 3. Bonding wire; 4. Primary PCB; 5. Secondary PCB; 6. Line inlet.

### DETAILED WAYS OF IMPLEMENTATION

The preferred embodiments of the present invention are described below with reference to the accompanying drawings. It shall be understood that the preferred embodiments described herein are for explanatory and illustrative purposes only, and are not intended to limit the present invention.

Embodiments: Please refer to Drawings 1-2. The present invention is a highly elastic antenna made of bonding wires, comprising a base plate (1), a line matched transformer (2), bonding wires (3), a primary PCB (4), a secondary PCB (5) and a line inlet (6). The upper part of the said base plate (1) is provided with a line matched transformer (2), a bonding wires (3), a primary PCB and a secondary PCB (5); one end of the said primary PCB (4) is connected to the line inlet (6); a line matched transformer (2) is fixed on the upper part of the primary PCB (4); and the primary PCB (4) is connected to the secondary PCB (5) via bonding wires (3). The said bonding wire (3) contains one or more wires; both ends of the bonding wire (3) are soldered to the upper part of the primary PCB board (4) and the secondary PCB board (5) respectively; one end of the said bonding wire (3) is perpendicular to the primary PCB (4), and the bonding wire (3) is of an arched structure; the said bonding wire (3) is placed at different heights; the said bonding wire (3) may be applied to any double-doublet antenna or monopole antenna design on PCBs.

It shall be noted that the present invention is a highly elastic antenna made of bonding wires that, in operation, serves as a component of antenna radiating elements. As a radiating antenna, the bonding wire may extend into the third dimensional space via its height, thus reducing the space occupied by the antenna on the PCB. One or more bonding wires may be used for different PCB antennas, and the resonant frequency may be adjusted by the length or height of the bonding wire. Finally, it shall be noted that the above description is only a preferred embodiment of the present invention, and is not intended to limit the present invention. Although the present invention has been described in detail with reference to the stated embodiments, for those skilled in the art, it is still possible to modify the technical scheme described in the stated embodiments, or to make an equivalent substitution to some of the technical features. Any modifications, equivalent substitutions, improvements, etc. made within the spirit and scope of the present invention shall be included within the scope of protection of the present invention.

1. A highly elastic antenna made of bonding wires, comprising a base plate, a line matched transformer, bonding wires, a primary PCB, a secondary PCB, and a line inlet, wherein the upper part of the base plate is provided with a line matched transformer, bonding wires, a primary PCB, and a secondary PCB; one end of the PCB is connected to the line inlet; a line matched transformer is fixed at the upper part of the primary PCB; and the primary PCB is connected to the secondary PCB via a bonding wire.

2. A highly flexible antenna made of bonding wires according to claim 1, wherein the bonding wire contains one or more wires.

3. A highly flexible antenna made of bonding wires according to claim 1, wherein both ends of the bonding wire are soldered to the upper part of the primary PCB board and the secondary PCB board, respectively.

4. A highly flexible antenna made of bonding wires according to claim 1, wherein one end of the bonding wire is perpendicular to the primary PCB, and the bonding wire is of an arched structure.

5. A highly flexible antenna made of bonding wires according to claim 1, wherein the bonding wire is placed at different heights.

6. A highly flexible antenna made of bonding wires according to claim 1, the bonding wire may be applied to any double-doublet antenna or monopole antenna design on PCBs.
